(19) United States
(12) Patent Application Publication
(10) Pub. No.: US 2008/0111919 A1
(43) Pub. Date: May 15, 2008

(54) Multiplexed DVI and displayport transmitter

(75) Inventors: Jianbin Hao, San Jose, CA (US); Yanjing Ke, Union City, CA (US); Ning Zhu, San Jose, CA (US)

Correspondence Address: BLAKELY SOKOLOFF TAYLOR & ZAFMAN, 1279 OAKMEAD PARKWAY, SUNNYVALE, CA, 94085-4040, US

(73) Assignee: Analogix Semiconductor, Inc.

(21) Appl. No.: 11/598,921

(22) Filed: Nov. 13, 2006

(51) Int. Cl. H04N 7/04; H04N 5/38

(52) U.S. Cl. 348/469; 348/723; 348/E05.093; 348/E07.04

(57) ABSTRACT

A semiconductor device that can be used to process and transmit data in two dissimilar formats. DVI or DisplayPort (DPortV1) standardized formats are disclosed. This integration, which can be operated in each mode as fully compliant circuit with the specific standard, allows the same video capture and analog circuits to be configured and used for processing of both formats, thereby reducing the number of circuits required as well as the over all size of the integrated solution. Board space is also reduced by using this integrated chip. The use of the same chip in both applications also takes advantage of the manufacturing economy of scale to reduce the cost of the chip to the customer.

### BACKGROUND OF THE INVENTION

1. Field of the Invention

The present invention relates to digital video information display technology for use with PCs, consumer electronics and TVs, and more specifically to the integration of DVI and DisplayPort standards as a single circuit.

2. Prior Art

Digital Interfaces to display units and computers have been a bottle neck for high definition display in the past. In order to improve this, multiple and different standards have evolved over the years, with two standards being in force today. The digital visual interface (DVI), instituted in 1999, is a veteran interface and well known in the art. The DisplayPort, released in early 2006, has been promoted to address the high speed transmission link needed for video and audio data for the new displays.

A. DVI

In order to improve the area of display, in 1999, the Digital Display Work Group (DDWG) released the DVI standard. DVI uses the Transition Minimized Digital Signaling (TMDS) that has been used in previous interconnects to achieve the digital signal transmission. DVI supports a single high performance analog video, and further provides a dual channel digital interface option. Since its release, DVI has become the accepted interface of choice for the computer industry's digital video output.

Initial applications used the DVI-D or digital-only option in the standard. Currently DVI is offered with the analog and digital options on the host side interface. This provides a transition path from VGA's analog interface and allows a higher performance analog interface for displays using the analog only interface while offering customers the option for new digital displays.

The DVI standard defines and standardizes both the physical connector interface and its electrical performance. It also defines the cable link specification and test specifications. This combination was a first in the industry and a first leap to compliance testing that greatly improves DVI product compatibility across the companies that make them.

B. DisplayPort

DisplayPort is a new scalable industry standard for high speed digital display devices that was introduced by the Video Electronics Standards Association (VESA) to accommodate the growing market segment of personal computer (PC) and consumer electronics (CE) industries. It consolidates the internal and external connections, reducing complexities, while supporting the necessary features across industry applications. The standard allows scaling to next generation displays with higher refresh rates, resolution and color depths. The DisplayPort also has optional audio and content protection capability for application within PC and CE devices. The designed chips are expected to provide internal chip to chip and external box to box display connections.

This standard can efficiently link internal chip to chip display connections such as within a PC, driving the display panel from a graphic controller, and within a TV, driving a display component from a display controller. It can also allow box to box connections between PCs and monitors, projectors, and TV displays. DisplayPort is also suitable for display connections between consumer devices like set-top Boxes, TV displays and Optical-disc players.

The DisplayPort meets the needs of the current PC and CE industry and also supports future scaling as necessary. The industry needs of the DisplayPort include: maximum application and re-use of the digital technology to reduce device cost of display connections; provide high speed, currently at 2.7 Gbps/link, and performance over fewer wires; provide same signaling methodology for internal and external display connections to reduce complexity; support optional content protection that can be easily implemented; provide capability for optional high quality audio transmission; and, apply an embedded clock scheme to reduce EMI susceptibility. It is therefore expected that the DisplayPort standard will achieve wide acceptance in the display, PC and CE industries in the near future.

The DVI standard today forms the most common transmission interface for video connections. This standard does not include the audio transmission interface, though there is a move to bring this into the standard. The DisplayPort can be considered the most advanced standard for the future. In order to cater to both the formats it is necessary today to have two separate chips on the board. The integration of these has not been possible in the past due to the completely differing characteristics and specification of the two formats as well as drive and bias requirements. Integrating the two would under normal practice produce a chip which will be large and be more complex than the individual chips, as the two specifications differ substantially. Therefore it would be advantageous to provide a solution that will enable the integration of the DVI and DisplayPort standards as a single circuit, and preferably as a single integrated circuit.

### BRIEF DESCRIPTION OF THE DRAWINGS

FIG. 1 is a top level block diagram of a DVI/DisplayPort transmitter.

FIG. 2 is a block diagram of DVI/DisplayPort multiplexing scheme.

FIG. 3 is a circuit diagram of the components of the serializer and transmitter driver.

FIG. 4 is a schematic diagram of a transmitter driver impedance switching scheme.

### DETAILED DESCRIPTION OF THE PREFERRED EMBODIMENTS

The present invention comprises a semiconductor device that can be used to process and transmit data in two dissimilar formats. The exemplary embodiment disclosed herein uses the DVI and DisplayPort (DPortV1) standardized formats. This integration, which can be operated in each mode as a fully compliant circuit for the respective specific standard, allows the same video capture and analog circuits to be configured and used for processing of both formats, thereby reducing the number of circuits required as well as the overall size of the integrated solution. Board space is also reduced by using this integrated chip. The use of the same chip in both applications also takes advantage of the manufacturing economy of scale to reduce the cost of the chip to the customer.

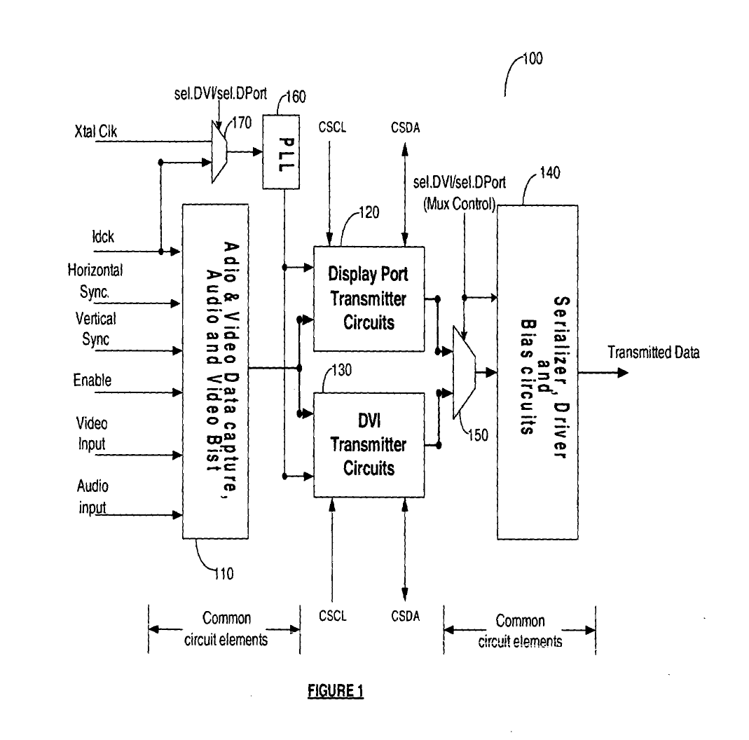

FIG. 1 is an exemplary and non-limiting top level block diagram 100 of the DVI/Displayport (DPort) device in accordance with the disclosed invention. It contains three major regions, of which two are common to the two formats, while one has individual sections dedicated to DVI or DisplayPort applications, thereby accounting to only those portions that differ between the two.

The first section is the Audio and Video Data Capture (AVDC) section 110 which is a common section for the two formats. The inputs to AVDC 110 are captured and format detection and data buffering is performed. In one embodiment of the disclosed invention, AVDC 110 provides the built-in-self-test BIST data generation capability for the audio and video streams.

The second section is specific to the format used and hence is a dedicated data processing transmitter section that comprises a DisplayPort transmission circuit 120 and DVI transmission circuit 130. Depending on the mode chosen, DVI or DisplayPort, only the respective transmitter section will be actively handling data. In the transmitter section the data is packed, framed, scrambled and encoded, as may be required using the specific methods in the chosen format specification. The digital data is encoded using ANSI standard 8B/10B encoding scheme in DisplayPort mode and TMDS encoding scheme in DVI mode. The transmitter section delivers this encoded data stream in the required data format to the serializer circuits through a multiplexer 150 as discussed below.

The third section comprises the data multiplexer 150, analog serializer 140, further includes the drivers and the necessary additional circuits to provide the bias generation and driver configuration, based on the chosen mode of operation, that is, either DVI or DisplayPort. The serializer circuits 140 receive the data from the transmitter section 120 or 130 through the multiplexer 150. Multiplexer 150 transfers the data from the transmitter chosen by the mode selector, using the selection control input sel.DVI /sel.DPort, based on the type of transmission mode selected DVI or DisplayPort. The serializer circuit serializes the data and provides the serialized data to the driver. The driver distributes the data on the data channels for transmission to the receiver over the link. The 10-bit coded data is serialized in such a way that the least significant bit (LSB) is transmitted first and the most significant bit (MSB) last.

The two auxiliary links shown in FIG. 1, CSCL and CSDA carry the command, control and status information between the transmitter and receiver. They handle the information transfer for hot plug-in, hand-shake, interrupt request, synchronization and other similar supervisory operations for the set-up, configuration and maintenance of the main transmission Link TXP/TXN.

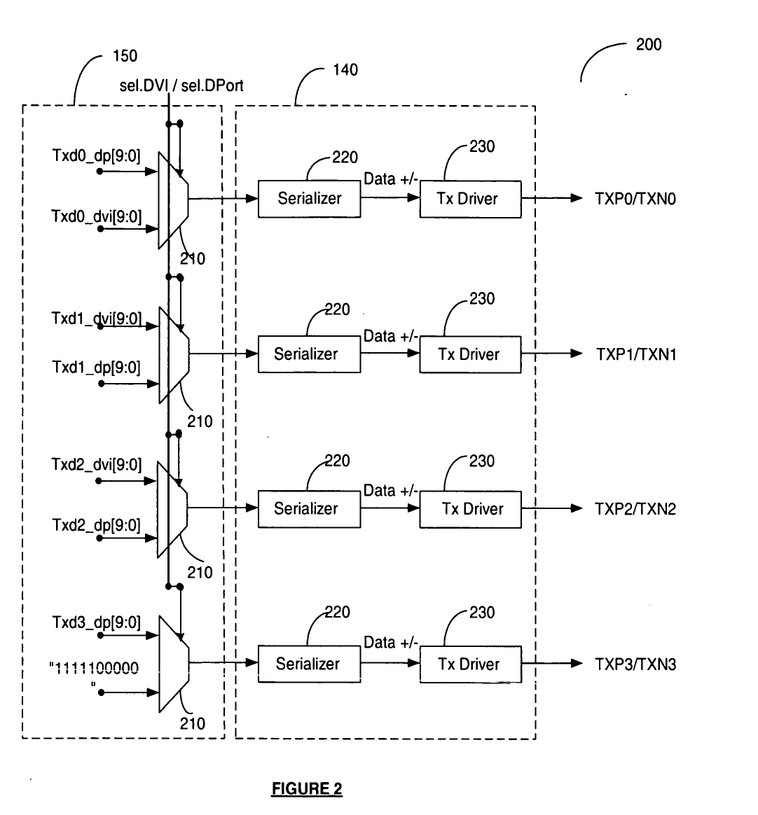

FIG. 2 shows a block diagram 200 of the DVI/DisplayPort multiplexing scheme with four links or channels for video data as per the DisplayPort specifications. The DVI specification, on the other hand, uses only three channels for Video Data. The 4^{th} channel under DVI mode is used as the line clock channel. This line clock (ldck) is used selectively by the PLL 160 of FIG. 1 to lock to the correct frequency of operation in the case of DVI transmission. A crystal clock ‘Xtal_Clk’ in FIG. 1 is used selectively to provide a stable lock frequency for the PLL in DisplayPort applications.

The output of the selected one of the DVI transmitter 130 or DisplayPort transmitter 120 is passed through the Multiplexer 210 to the Serializer 220 and to the Tx Driver 230 for transmission.

The PLL 160, shown in block diagram 100 or circuit diagram 300, generates the clock signal ‘PLL_clock’ which has the same frequency as the output data rate. In DVI mode, the data rate varies between 250 Mbps and 1.65 Gbps. In DisplayPort mode, the data rate is fixed at 2.7 Gbps.

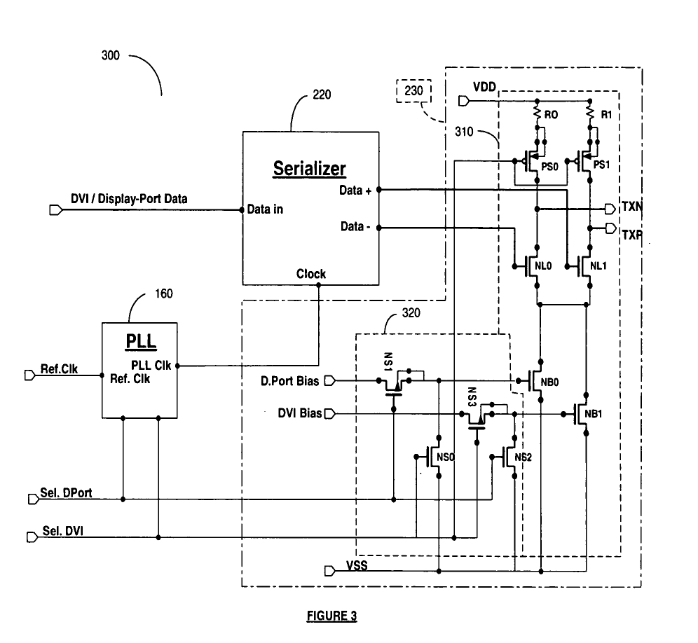

The serializer 220 converts the 10 bit parallel input data from DisplayPort/DVI data input into serial data and sends it to the output driver block 230 to provide the input gate drive for the N-channel devices NL0 and NL1 of the drive circuit shown in FIG. 3.

FIG. 3 shows an exemplary and non-limiting circuit design 300 of a single exemplary channel of the analog shared portion of the serializer circuits 140. This circuit design 300 shows the serializer 220 and the Tr Driver 230 of FIG. 2. The Tx Driver 230 consists of a driver section 310, and a bias generator circuits section 320 for the drivers. The Bias Generator 320 consists of two biasing circuits, one of which can be turned on to bias the output drivers 310 based on the selection of the DVI or DisplayPort operation of the transmitter.

The output driver 310 is connected as a differential operational amplifier. It is composed by transistors NB0, NB1, NL0, NL1, PS0, PS1 and 2 resistors R0 and R1. The output driver works under two different bias conditions, D.Port Bias and DVI_Bias. They are separately controlled by select_DisplayPort (Sel. D.Port) and select_DVI (Sel DVI) signals generated from the mode signal DVI/DP shown in the block diagram 100. Similarly the two select signals selecting the DisplayPort or DVI are also generated from the mode signal DVI/DP. Only one of ‘DisplayPort_bias’ and ‘DVI_bias’ signals is active at a given time. The transistors NS0, NS1, NS2 and NS3, of bias control circuit 320, are used to control the switching between DisplayPort and DVI bias conditions. The transistors NB1 and NB1 are driven by DisplayPort_bias signal and DVI_bias signal separately. These bias signals may be, by way of example, signals from current mirrors, so that one current may be mirrored to transistor NB1 and another current may be mirrored to transistor NB1. Still at any one time, only transistor NB0 or NB1 is active, not both, the gate of the inactive device being coupled to ground by one of transistors NS0 and NS2. Thus transistor NB0 or transistor NB1 generates the bias current to the output driver. The differential NMOS transistor pair, NL0 and NL1 of output driver 310 are designed in such a way that the output driver will work under both bias conditions.

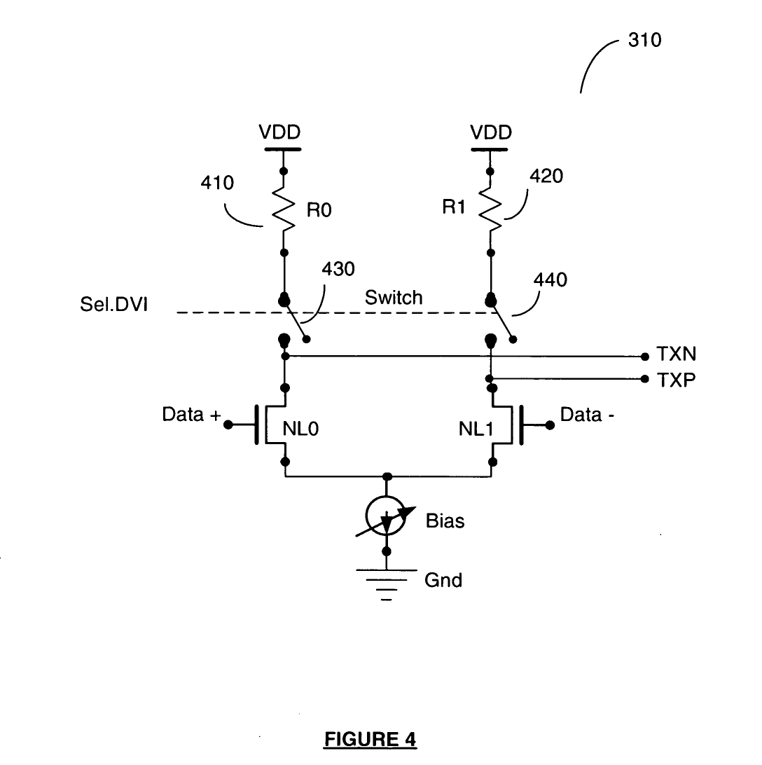

FIG. 4 is a representation of the termination switching scheme of the output driver 310. The termination resistors R0 410 and R1 420, typically 50 ohm each, are not used in DVI mode since DVI mode uses sink side termination. The ‘select_DVI’ signal is used to control transistors PS0 and PS1 shown here as switches 430 and 440 respectively. When ‘select_DVI’ signal is high, the switches are not turned on so that the resistors 410 and 420 are disconnected from the circuit of output driver 310. This selective termination switching allows the driver circuit 310 to meet the electrical specification of both DVI and DisplayPort standards. Further, in order to cater to the frequency range and electrical characteristics the circuits, the devices used in the integrated circuit are optimized for the most demanding electrical characteristics under the two operating conditions of DVI and DisplayPort.

Thus while certain preferred embodiments of the present invention have been disclosed and described herein for purposes of illustration and not for purposes of limitation, it will be understood by those skilled in the art that various changes in form and detail may be made therein without departing from the spirit and scope of the invention.

What is claimed is:

1. Apparatus for multiplexing and transmitting two dissimilar display formats in compliance with the standards defining each respective display format comprising:
audio and video data capture circuits;
a first transmitter for said first display format having an input coupled to said audio and video data capture circuits;
a second transmitter for said second display format having an input coupled to said audio and video data capture circuits;
a multiplexer having inputs coupled to outputs of the first and second transmitters for selecting between the first display format and the second display format responsive to a select signal;
a serializer circuit coupled to an output of the multiplexer for serially transmitting the output of the multiplexer; and,
a transmit driver responsive to the select signal to transmit an output of the serializer in accordance with the selected display format standard.

2. The apparatus of claim 1, wherein the multiplexer, the serializer and the transmit driver are configured to meet the most demanding electrical requirements of both the first display format standard and said second display format standard.

3. The apparatus of claim 1, wherein the transmit driver provides selective biasing responsive to the select signal to enable the output driver to selectively meet the first display format specification and the second display format specification.

4. The apparatus of claim 1, wherein the transmit driver selectively alters an output termination of the transmit driver responsive to said selecting signal to selectively meet the first display format specification and the second display format specification.

5. The apparatus of claim 1, wherein said first display format is DVI and said second display format is DisplayPort.

6. The apparatus of claim 5, wherein said audio and video capture circuits are common for the two dissimilar display formats.

7. The apparatus of claim 1, wherein said apparatus is an integrated circuit.

8. A method for producing an apparatus that multiplexes two dissimilar display formats, each format with its own electrical requirements, comprising:
enabling circuit elements of said apparatus to have a characteristics range to include the most demanding electrical requirements of the two dissimilar display formats and be further common to the two dissimilar display formats;
enabling circuit elements of said apparatus to handle by separate circuits, dissimilar transmitters for said two dissimilar display formats;
enabling a driver circuit a mode selection signal for configuration and biasing to achieve output drive characteristics of the two dissimilar display formats; and,
enabling said driver circuit to uniquely switch the termination impedances to meet the drive termination specification of the two dissimilar display formats.

9. The method of claim 8, wherein said two dissimilar display formats are DVI and DisplayPort.

10. The method of claim 8 wherein the method is practiced in an integrated circuit.

11. A method for efficiently handling two dissimilar display formats comprising:
capturing the audio and video data signals;
selecting between a first display format and a second display format of the two dissimilar display formats;
transmitting the data signal of the selected one of said first display format and said second display format of the two dissimilar display formats;
adapting said data signal to provide the output drive characteristics of the selected one of the two dissimilar display formats.

12. The method of claim 11, further comprising:
meeting the most demanding electrical requirements of said first display format and said second display format.

13. The method of claim 11, further comprising:
selecting the output termination responsive of said selecting signal.

14. The method of claim 11, wherein said first display format is DVI and said second display format is DisplayPort.

15. The method of claim 11 wherein the method is practiced in an integrated circuit.
